(19) United States
(12) Patent Application Publication
(10) Pub. No.: US 2003/0070168 A1
(43) Pub. Date: Apr. 10, 2003

(54) Method and apparatus for editing an electronic program guide

(76) Inventor: Christopher J. Stone, Newtown, PA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/973,573

(22) Filed: Oct. 9, 2001

(51) Int. Cl. G06F 13/00

(52) U.S. Cl. 725/37

(57) ABSTRACT

An electronic program guide can be configured by obtaining at a remote controller for a content receiver, such as a set top box, a listing of the available programming from a content provider and filtering the program material at the remote controller so as to filter programming which has not been subscribed to by the user or parental access restricted programming or programming which the user requests be omitted from the program guide. Thus, according to this embodiment, a user can tailor the electronic program guide to the user's preferences.

The embodiments of this invention relate generally to program guides. More specifically, they relate to a system for editing a program guide.

### BACKGROUND

Electronic program guides currently exist that allow a user to receive a complete listing of the programs or channels available for viewing. For example, such electronic program guides provide a cable tv customer with a complete listing of all the available channels that the cable company has to offer. Even though a user does not subscribe to the complete listing of programs, these electronic program guides nevertheless display the entire listing of the programs offered by that cable tv company. Similarly, when alternative program content is offered in addition to television programming, those channels or programs are also displayed on the electronic program guide.

As a result, a user is often presented a very long listing of programs or channels that are not necessarily available to that particular user. Even though one does not subscribe to subscription based services, that programming will nevertheless be displayed to the user as part of current program guides. For example, if the user does not receive HBO™, SHOWTIME™, or CINEMAX™, the display of those channels in a program guide will be of no use to that particular user. Rather, the display of those channels will actually be a detriment to the user in selecting a program to view. For example, a hotel that does not offer such subscription services will result in frustrated hotel guests that see the subscription services listed on the electronic program guide without being able to access those particular services. As another example, in electronic program guides that have a significant number of programs listed, the additional listings that are not available will prevent a user from making a quick determination of the program that the user desires to receive.

### SUMMARY

A first embodiment of the invention provides a method to edit program listings by obtaining a list of programs offered for viewing; compiling at a content provider device a second list of programs that the user is entitled to receive; and communicating the second list to a remote controller.

Another embodiment of the invention provides a method of providing program information wherein the method comprises obtaining a list of programs offered for viewing by a user; communicating the list of programs to a remote controller; compiling at the remote controller a second list of programs that the user is entitled to receive; and, displaying the second list of programs on the remote controller.

Another embodiment of the invention provides a method of providing program information, wherein the method comprises obtaining a list of programs offered for viewing; storing multiple user profiles; selecting at least one of the user profiles; utilizing the selected user profile and the list of programs to compile a second list of programs that are accessible to the user of the selected user profile; and, displaying the second list on a remote controller.

Another embodiment of the invention provides an apparatus that can be used for providing program information. The apparatus is comprised of a processor; a memory coupled to the processor; a display coupled to the processor; and code operable to obtain a list of programs offered for viewing; code operable to store multiple user profiles; code operable to select one of the multiple user profiles; code operable to utilize the selected user profile and the list of programs to compile a second list of programs accessible to the user of the selected user profile; and, code operable to display the second list on the display.

In various embodiments of the invention, the electronic program guide can be edited by utilizing a data set of program listings which reflect programs or channels previously removed from a user's profile or a profile previously established by a user. Similarly parental controls can be used to edit a user's profile. In addition, channels or programs not subscribed to by a user can be edited from the user's profile.

In one embodiment of the invention multiple user profiles can be programmed into the remote controller so that the remote controller can be utilized by all of the different users whose profiles are stored in the remote controller. For example, profiles for an entire family can be stored in a single remote controller to allow each family member to use his/her respective profile listing.

Further embodiments of the invention will be apparent to those of ordinary skill in the art from a consideration of the following description taken in conjunction with the accompanying drawings, wherein certain methods, apparatuses, and articles of manufacture for practicing the various embodiments of the invention are illustrated. However, it is to be understood that the invention is not limited to the details disclosed but includes all such variations and modifications as fall within the spirit of the invention and the scope of the claims.

### BRIEF DESCRIPTION OF THE DRAWINGS

FIG. 1 is a flow chart illustrating an embodiment of the invention for editing a program guide and communicating the edited program guide to a remote controller.

FIG. 2 illustrates a flow chart for another embodiment of the invention that compiles at the remote controller an edited program guide for display on the remote controller.

FIG. 3 illustrates an embodiment of the invention demonstrating various ways in which a user can edit a program guide such as via parental control settings, a user's subscriptions, and/or previously removed channels.

FIG. 4 illustrates a flow chart for an embodiment of the invention in which a user profile is selected from a list of multiple user profiles and a modified program guide is displayed on the remote controller.

FIG. 5 illustrates a system for providing program content from a source(s) to a content receiver that is also accessible by a remote controller.

FIG. 6 illustrates a system for accomplishing the remote controller shown in FIG. 5.

FIG. 7 illustrates an interactive diagram for one embodiment of the invention that allows a user to remove selected channels or programs from an electronic program guide.

FIG. 8 illustrates an interactive diagram for one embodiment of the invention that allows access control information to be utilized to modify an electronic program guide.

FIG. 9 illustrates an interactive diagram for one embodiment of the invention that allows parental control information to be utilized to edit the electronic program guide.

FIG. 10 illustrates a remote controller displaying a plurality of users that can be accessed so as to access a specific user profile and display a specific electronic program guide for that particular user.

### DETAILED DESCRIPTION

Electronic program guides in the past have merely displayed an entire listing of programs that are provided by a content provider such as a cable tv head-end. In many instances, such a large number of programs require some time to read through even though not all the programs displayed are available to that particular user. For example, when subscription services such as HBO™ or SHOWTIME™ are displayed but not subscribed to by a user, the display of such programs on the electronic program guide is unnecessary and time consuming for a user. The embodiments of the present invention provide for a system which allows a user to edit an electronic program guide so as to customize the electronic program guide for a particular user.

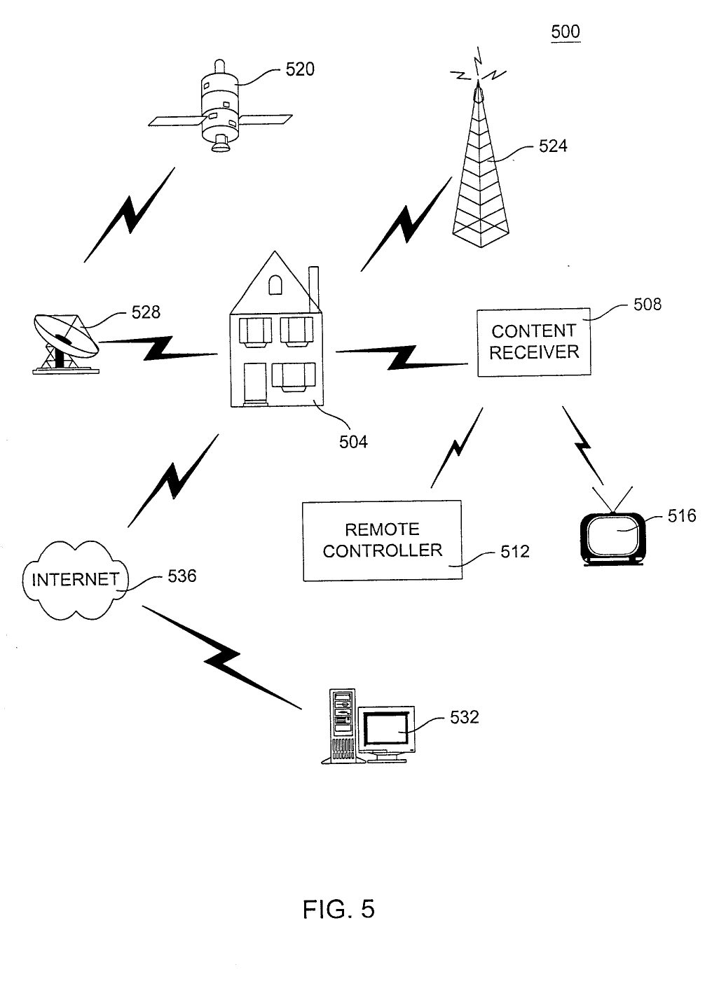

FIG. 5 illustrates a system for implementing one embodiment of the invention. In FIG. 5 a content provider such as a cable head-end 504 provides content or programming for a content receiver such as a set top box 508. The content receiver can then provide a specific program or channel to a television set 516. The remote controller 512 coupled to the content receiver 508 can control the selection of a specific program or channel. A content provider is intended to mean a system that provides content for viewing by a user. For example, one example of a content provider is a cable head-end which supplies cable television programming for use by a viewer. Such programming can include not only television programs, but also, music programming, and the like. Similarly, content can be provided over a network, such as the interenet, for access by a user. Thus, a server that provides program content over the interet could similarly be considered a content provider. A content receiver is considered to be the primary unit under the control of a user which receives program content from a content provider(s). For example, a set-top box is considered to be a content receiver, in that it receives program content from a content provider such as a cable head-end. A remote controller is intended to mean a remote device which can be used with a content receiver, such as a set-top box, to display for selection by a user a listing of channels or programs that a user can select from, e.g., an electronic program guide. The remote controller is a device which is remote from the set-top box, although in some instances it might be electrically coupled to the set-top box. For example, an internet appliance with the applicable software and/or hardware is considered to be a remote controller, in that it has the ability to change the channel and adjust other characteristics of the content receiver. The remote controller device can be coupled to the content receiver in a variety of ways. For example, the remote controller could be wired to the content receiver by utilizing modulated RF over cable. Similarly, a USB bus could be utilized. Other alternatives include RJ-45 (Ethernet), IEEE-1394 (FIREWIRE, iLINK), RS-232, or any other serial connection. If a wireless coupling is desired, 802.11 WLAN, HOMERF, HyperLAN, RF 1394, dedicated RFWLAN, infrared, or IrDA or any other wireless technology could be utilized.

The head-end 504 can receive content from multiple sources. For example, a cable head-end can receive a satellite transmission transmitted from a satellite 520 in orbit to a satellite receiving dish 528 which is coupled to the head-end. Furthermore, a local television station can transmit programming via transmitter 524 to the head-end. Furthermore, with the advent of data content on networks such as the internet 536, such programming can be transmitted across the network from a server 532 to the head-end. Thus with the growing number of sources of programming, a user will soon be inundated with numerous choices of programming from which he or she can choose. Thus an embodiment of the invention which allows the user to tailor this listing of choices will be useful.

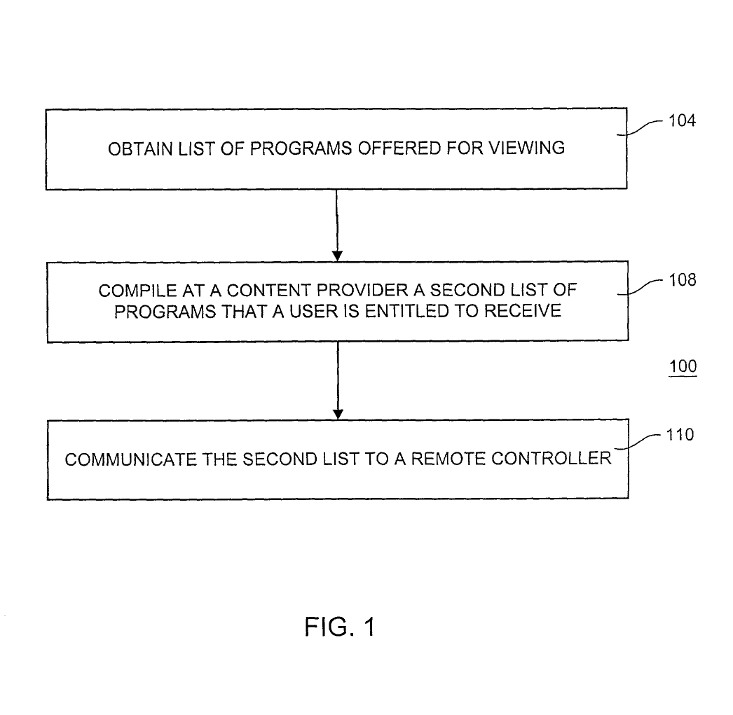

FIG. 1 lists one embodiment of narrowing the choice of programs offered for viewing, e.g., in an electronic program guide. In method 100 of FIG. 1, a list of programs that are being offered for viewing is obtained as shown in block 104. In block 108 a second list of programs is compiled at a content provider such as head-end 504 of FIG. 5. This second list of programs is a list of programs that the user is entitled to receive. For example, this could be the list of programs that the user has subscribed to thus excluding the list of programs that the user has not subscribed to. Furthermore, this list could alternatively or in addition be limited by the parental access controls that were established for a particular user. Thus, if the user profile for a child were being configured, the available list of programs in the program guide that the child would be entitled to see would be narrowed to remove any channels indicated by the parental control settings. In block 110 this second list is communicated to the remote controller such as remote controller 512 in FIG. 5. Thus, the remote controller can either display the second list received directly on a display of the remote controller or alternatively, utilize the second list to filter the entire list of programs offered for viewing. Thus, if the remote controller receives a list of channels that a user was entitled to view, those channels could be cross-referenced against a list of programming for the entire content available from a head-end so as to filter out any programs which the user is not entitled to receive.

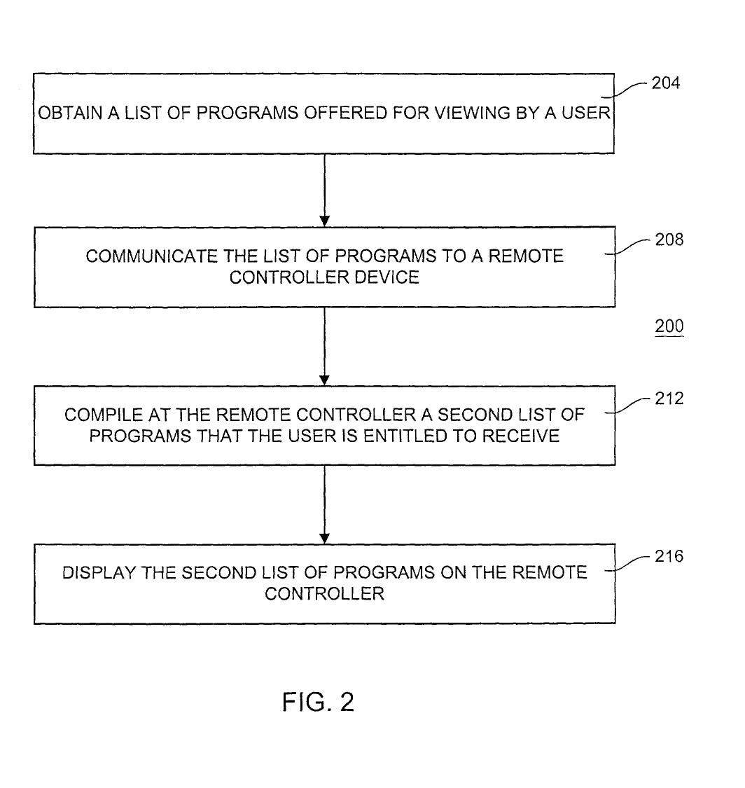

FIG. 2 illustrates a method 200 according to another embodiment of the invention. In block 204 of FIG. 2, a list of programs offered for viewing by a user is obtained. Again, this list could include the entire list of programming offered, for example, by a cable head-end. The list is communicated to a remote controller device as shown in block 208. In block 212 a second list of programs that the user is entitled to receive is compiled at the remote controller. Furthermore, in block 216 this second list of programs can be displayed on the remote controller for use by a user in selecting a program to view. Thus, according to this embodiment of the invention, the available list of programs can be compiled at the remote controller as opposed to being compiled at the head-end or content receiver such as a set top box. Thus, the set top box can store a variety of filter data sets for different users while allowing the remote controller to actually determine a configuration for a specific user.

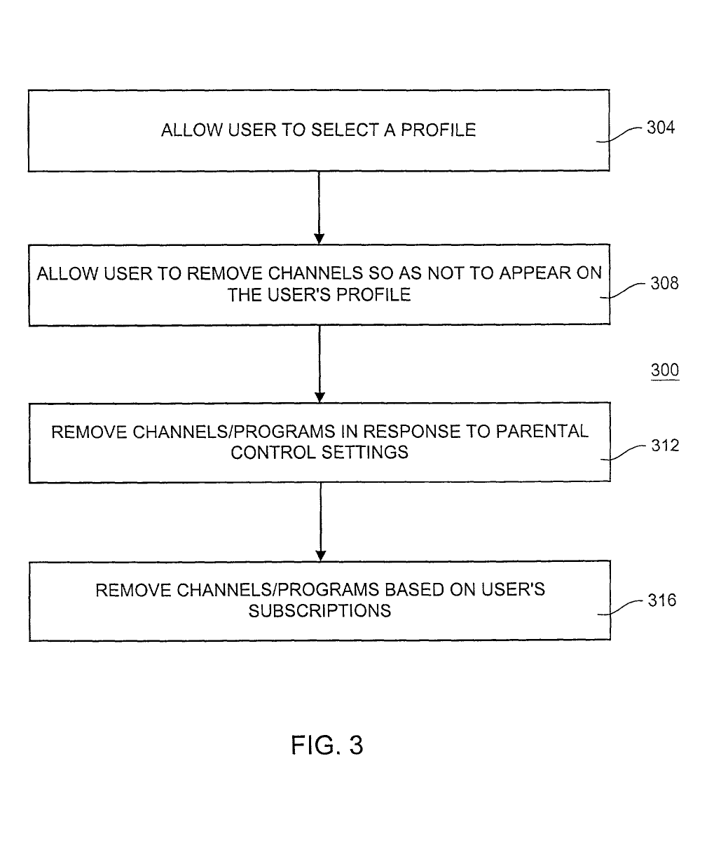

FIG. 3 illustrates a method 300 according to another embodiment of the invention. FIG. 3 illustrates in more detail how a configuration can be established for a specific user. In block 304 of FIG. 3, a user is allowed to select a specific profile from a remote controller display. Thus a display could provide multiple names at the outset such that the user can select his or her name from the display. A password could be utilized for selecting a specific user profile so as to prevent a child from accessing an adult's profile. In block 308, a user is allowed to remove channels from the current profile of the user so that those selected channels no longer appear on the user's profile. Thus a user can manually designate any channel which he or she knows is of no interest to that particular user and indicate that it should be removed.

Furthermore, in block 312 channels can be removed in response to parental control settings received from either the cable head-end or content receiver such as the set top box. Thus, a list of programs that are censored for a particular user can be used to filter the profile for that user. As shown in block 316 channels or programs can be removed based on which channels a user has subscribed to. If a user has not subscribed to HBO™ or SHOWTIME™, for example, then that information can be obtained from the cable head-end and used to filter the user's profile so that those channels are no longer displayed on the user's profile.

Furthermore, the process can repeat itself so that the user can again manually remove channels that are no longer of interest to that particular user. Furthermore, a reset option can be used to allow a user to start the process over so that channels that were previously manually removed again appear on the user's profile. This would allow a user to refresh the profile with channels that were previously removed.

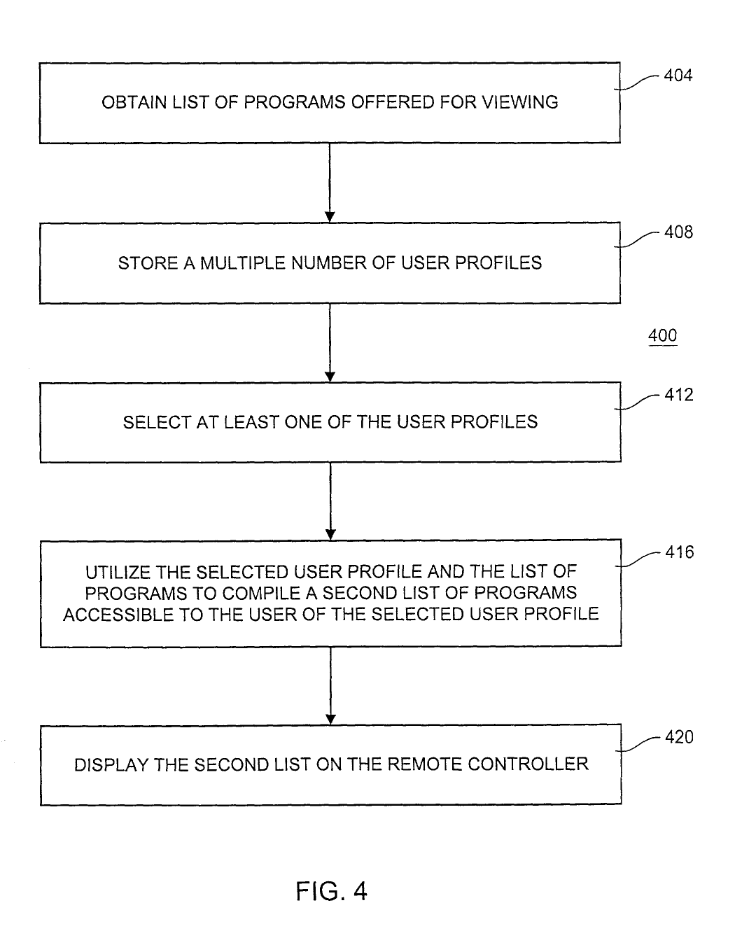

In many instances the remote controller device will be utilized by an entire family or a group of users. Thus, according to one embodiment of the invention a system is provided that allows these multiple users to utilize individual profiles on a single remote controller. In method 400 of FIG. 4, a list of programs offered for viewing is obtained as shown in block 404. Furthermore, a multiple number of user profiles is stored as shown in block 408. This multiple number of profiles can be stored, for example, on the content receiver or on the remote controller itself. In block 412 a user selects at least one of the user profiles that is displayed on the remote controller. Namely, a user would select the profile specific to that particular user. In block 416, the selected user profile and the obtained list of programs are utilized to compile a second list of programs accessible to the user of the selected user profile. Again, this can be accomplished by modifying an entire list of programs with subscription information, parental control information, and/or previous profile configurations for that user. The second list of programs can then be displayed on the remote controller as shown in block 420. Furthermore, this second list of programs can be further modified manually by the user and saved as a new user configuration.

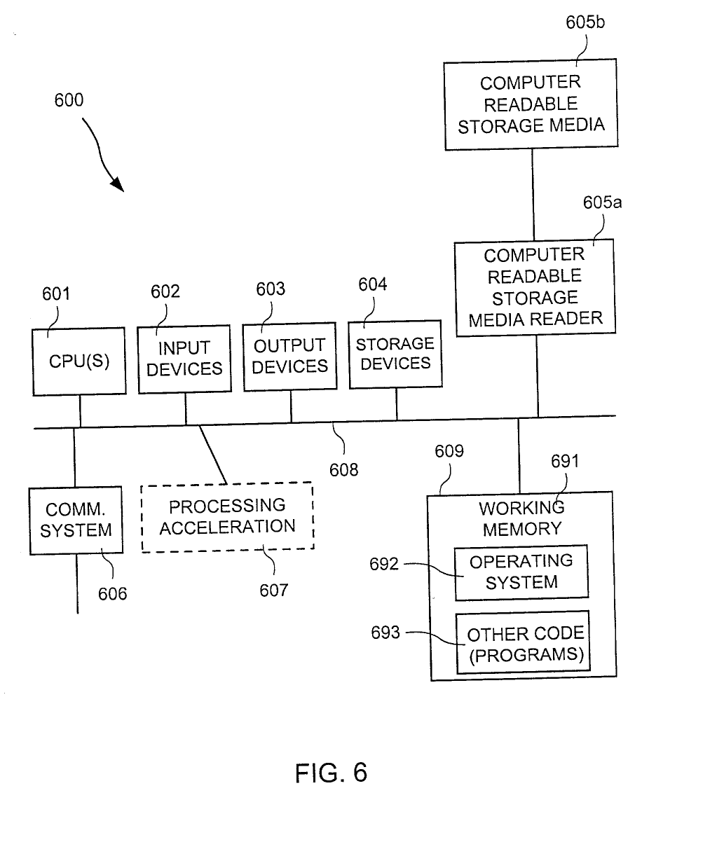

FIG. 6 illustrates a system for accomplishing the content provider, the content receiver, and the remote controller. System 600 is shown comprised of hardware elements that are electrically coupled via bus 608, including a processor 601, input device 602, output device 603, storage device 604, computer-readable storage media reader 605a, communications system 606 processing acceleration (e.g., DSP or special-purpose processors) 607 and memory 609. Computer-readable storage media reader 605a is further connected to computer-readable storage media 605b, the combination comprehensively representing remote, local, fixed and/or removable storage devices plus storage media, memory, etc. for temporarily and/or more permanently containing computer-readable information, which can include storage device 604, memory 609 and/or any other such accessible system 600 resource. System 600 also comprises software elements (shown as being currently located within working memory 691) including an operating system 692 and other code 693, such as programs, applets, data and the like.

System 600 is desirable as an implementation alternative largely due to its extensive flexibility and configurability consistent with that already enabled by the system 500 of FIG. 5. Thus, for example, a single architecture might be utilized to implement one or more servers that can be further configured in accordance with currently desirable protocols, protocol variations, extensions, etc. However, it will be apparent to those skilled in the art that substantial variations may well be utilized in accordance with more specific application requirements. For example, one or more system 500 elements might be implemented as sub-elements within a system 600 component (e.g. within communications system 606). Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized. Distributed processing, multiple site viewing, information forwarding, collaboration, remote information retrieval and merging, and related capabilities are each contemplated. Operating system utilization will also vary depending on the particular host devices and/or process types (e.g. computer, appliance, portable device, etc.) and certainly not all system 600 components will be required in all cases.

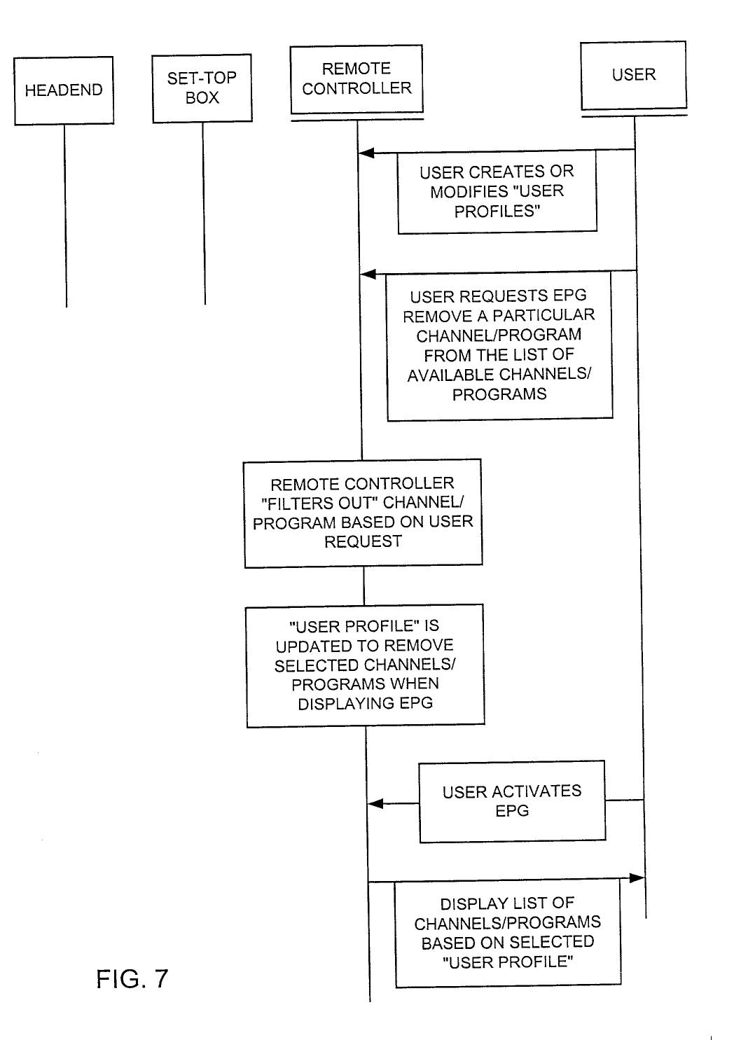

FIG. 7 illustrates an interactive diagram, for example, between a head-end, set top box, remote controller, and a user. In FIG. 7 the head-end and set top box remain idle while the remote controller is manipulated by the user to remove programs from the user's profile. As shown in FIG. 7, the user creates or modifies the user profile by requesting the electronic program guide to remove a particular channel or program from the list of available channels or programs. The remote controller receives this request and filters out the channel or program based on the user's request. The user profile is then updated to remove the selected channel or program when displaying the electronic program guide. Thus, when the user activates the electronic program guide on the remote controller, a list of channels or programs is displayed on the remote controller display based on the selected user profile.

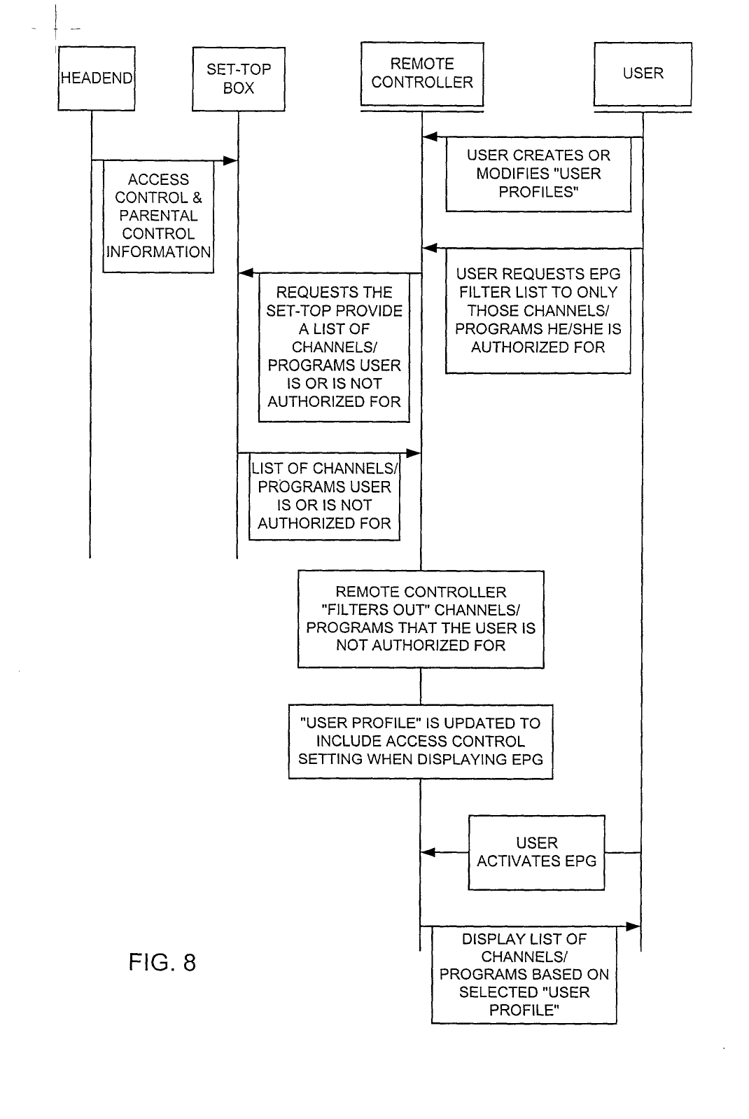

In FIG. 8 another interactive diagram is shown which allows for modification of a user profile. In FIG. 8 the user selects a user profile input, such as a user profile icon on the remote controller. The user requests the electronic program guide to filter the list to only those channels or programs that he or she is authorized for. The set top box has previously obtained access control and parental control information from the head-end. Thus, the remote controller can request the set top box to provide a list of channels or programs that the user is or is not authorized for. This list of channels and programs the user is or is not authorized for can then be communicated to the remote controller. The remote controller can then filter out the channels or programs that the user is not authorized for from the user profile in existence at that time. Thus, the user profile is updated to include access control settings when displaying the electronic program guide. The user activates the electronic program guide by inputting a command into the remote controller. Upon receipt of the command, the remote controller displays to the user a list of channels or programs based on the selected user profile.

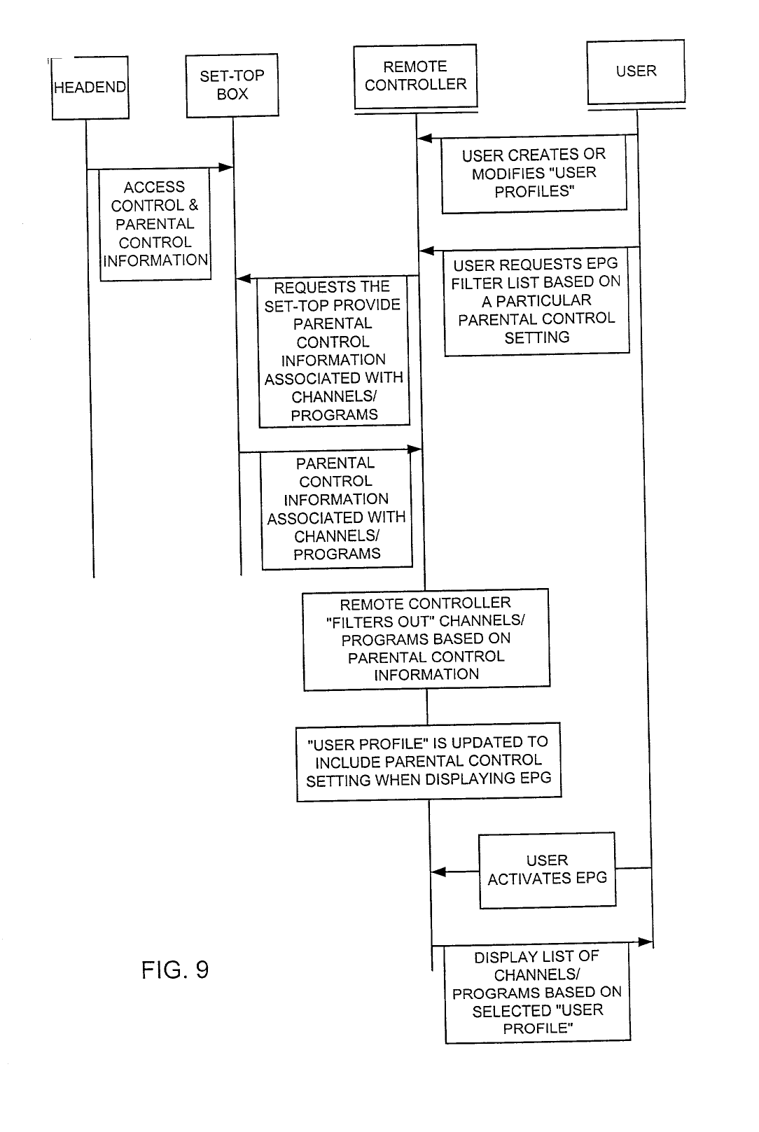

FIG. 9 illustrates a similar interactive diagram for the head-end, set top box, remote controller, and user. In FIG. 9 the process works similar to that shown in FIG. 8 except the remote controller requests that the set top box provide parental control information associated with channels and programs. The set top box had obtained this information from the head-end and communicates the parental control information associated with the various channels and programs to the remote controller. The remote controller filters out the channels and programs based on the parental control information. Thus, the user profile is updated to include parental control and settings when displaying the electronic program guide. Upon the user activating the electronic program guide from the remote controller a list of channels or programs based on the selected user profile can be displayed.

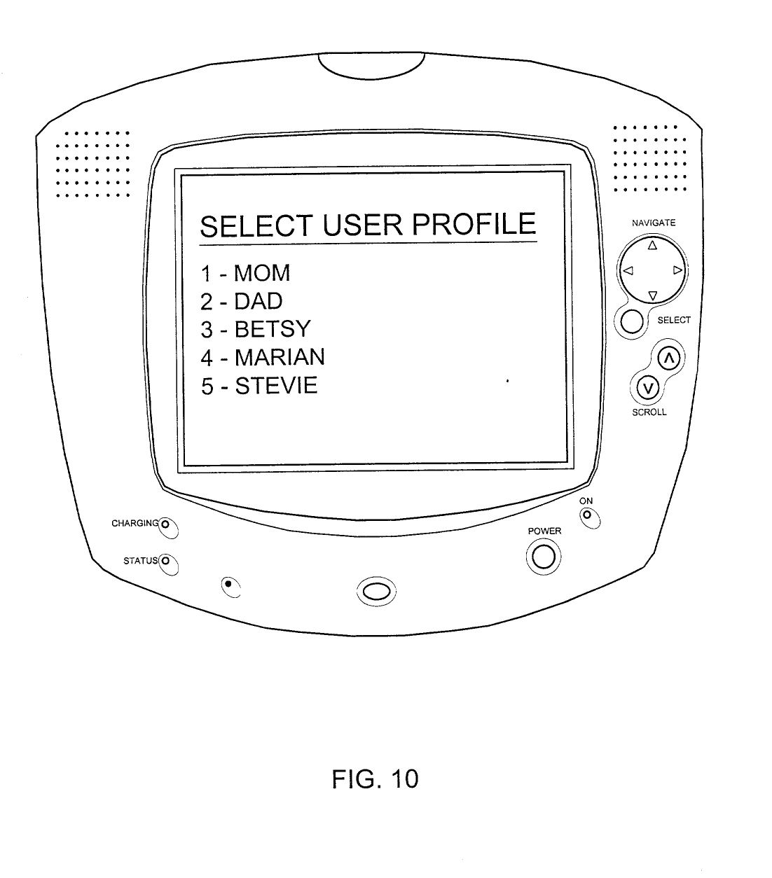

FIG. 10 illustrates an example of a remote controller device 1000 providing a display 1010. According to this example, a user of the remote controller can select from six different profiles. Thus, “Mom” and “Dad” can modify the user profile to their specific criteria. Furthermore, the adolescent children “Betsy” and “Marian” can modify their particular user profiles. In view of the fact that these are adolescent children, it is likely that some programs will be revised by the parental control information. Similarly, with the young child “Stevie”, the user profile can be modified and parental control information can be applied to that specific user profile. Finally, option 6 allows a new user profile to be added.

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or steps for performing a function. Therefore, it should be understood that such language is entitled to cover all such structures, materials, or acts disclosed within this specification and their equivalents.

It is thought that the apparatuses and methods of the embodiments of the present invention and many of its attendant advantages will be understood from this specification and it will be apparent that various changes may be made in the form, construction, and arrangement of the parts thereof without departing from the spirit and scope of the invention or sacrificing all of its material advantages, the form herein before described being merely exemplary embodiments thereof.

What is claimed is:

1. A method of providing program information, said method comprising:
obtaining a list of programs offered for viewing;
compiling at a content provider device a second list of programs that a user is entitled to receive;
communicating said second list to a remote controller.

2. The method as described in claim 1 wherein said compiling a second list comprises:
compiling said second list at a set-top box.

3. The method as described in claim 2 wherein said obtaining a list of programs offered for viewing comprises:
determining said list from cryptographic information for said list of programs.

4. A method of providing program information, said method comprising:
obtaining a list of programs offered for viewing by a user;
communicating said list of programs to a remote controller;
compiling at said remote controller a second list of programs that said user is entitled to receive;
displaying said second list of programs on said remote controller.

5. The method as described in claim 4 and further comprising:
allowing said user to remove channels so as not to appear on said second list of programs.

6. The method as described in claim 4 and further comprising:
selecting a profile of the user.

7. The method as described in claim 6 and further comprising:
utilizing said selected profile for said compiling said second list of programs.

8. The method as described in claim 6 and further comprising:
determining whether a control has been set for said user corresponding to at least one of said programs; and
if said control has been set for said user, removing said control from said second list.

9. The method as described in claim 8 wherein said control comprises a parental control.

10. The method as described in claim 6 and further comprising:
compiling said second list so as not to comprise programs that had been eliminated by said user.

11. The method as described in claim 6 and further comprising:
compiling said list so as not to comprise programs to which said user does not subscribe.

12. A method of providing program information, said method comprising:
obtaining a list of programs offered for viewing;
storing a plurality of user profiles;
selecting at least one of said plurality of user profiles;
utilizing said selected user profile and said list of programs to compile a second list of programs accessible to said user of said selected user profile;
displaying said second list on said remote controller.

13. The method as described in claim 12 and further comprising:
compiling said second list at a set-top box; and
communicating said second list to said remote controller.

14. The method as described in claim 12 and further comprising:
compiling said second list with said remote controller.

15. An apparatus for providing program information, said apparatus comprising:
a processor;
a memory coupled to said processor;
a display coupled to said processor;
code operable to obtain a list of programs offered for viewing;
code operable to store a plurality of user profiles;
code operable to select one of said plurality of user profiles;
code operable to utilize said selected user profile and said list of programs to compile a second list of programs accessible to said user of said selected user profile;
code operable to display said second list on said display.

16. The method as described in claim 15 and further comprising:
code operable to allow said user to remove a program.

17. The method as described in claim 15 and further comprising:
code operable to select at least one of said plurality of user profiles.

18. The method as described in claim 17 and further comprising:
code operable to utilize said profile to compile said second list.

19. The method as described in claim 17 and further comprising:
code operable to utilize parental control settings in compiling said list.

20. The method as described in claim 17 and further comprising:
code operable to compile said second list without programs previously removed by said user.

21. The method as described in claim 17 and further comprising:
code operable to compile said second list without programs not subscribed to by said user.
